(19) United States
(12) Patent Application Publication
(10) Pub. No.: US 2012/0119503 A1
(43) Pub. Date: May 17, 2012

(54) Submerged energy storage

(76) Inventor: Martinus van Breems, Norwalk, CT (US)

(21) Appl. No.: 13/065,884

(22) Filed: Mar. 31, 2011

Related U.S. Application Data
(60) Provisional application No. 61/341,585, filed on Apr. 1, 2010.

(51) Int. Cl. F03D 9/02; F03B 13/24

(52) U.S. Cl. 290/55; 137/565.18

(57) ABSTRACT

A submerged energy storage system and method incorporates a pump having a helix screw coupled with a storage tank on the sea floor and motive means, such as wind driven impellers or wave motion produced by sliding buoys or driving the screw of the pump.

### CROSS-REFERENCE TO RELATED PATENT APPLICATION

This application claims priority from prior U.S. provisional patent application Ser. No. 61/341,585 filed Apr. 1, 2010, the entire disclosure of which is incorporated herein by reference.

### BACKGROUND OF THE INVENTION

1. Field of the Invention

The present invention pertains to systems and methods for storing power/energy in offshore situations where the power source/energy is obtained from wind power or wave power.

2. Brief Discussion of the Related Art:

CAES (Compressed Air Energy Storage) systems offer a proven method of energy storage. Such systems are typically used for energy balancing, allowing electricity produced in off peak time periods to be stored by compressing and storing air, and are a viable alternative to pumped water storage systems. Suitable storage locations are typically underground caverns. However, no suitable geologic location exists in many areas and quoted efficiencies are about 50%, whereas pumped water storage can exceed 80% for the round trip.

Over 80% of the US population currently lives within 100 nautical miles (NM) of the US coastline, a figure that is projected to increase to over 90% by the year 2025. Offshore wind puts energy close to major population centers, and faces minimal location issues if over 12 miles offshore. Bat and bird kills are also virtually eliminated. A significant issue is the optimum depth. Existing commercial offshore wind farms are in less than 20 m water depths. In large part, this is due to installation methods that mimic those of onshore construction. With different methods, it can be cheaper to install units farther offshore. The only cost that will be higher is the longer power cable required. The first (floating) deep water wind turbine is currently undergoing testing off Norway.

The volume of a given quantity of air is reduced by 50% at 33.9 ft or 10.3 m, 75% at 20.6 m, 87% at 30.9 m and about 92% at 41.2 m. Less than 90% compression is unlikely, as the tank capacity has to be significantly larger. 40 m is likely to be the minimum depth. Of course, greater depth provides higher pressure and more force, but at greater expense.

40 m depths are about 2-10 NM from the US west coast and 10-30 NM from the US east coast. 100 m depths are generally 10 to 30 NM from the US west coast and 60 to 80 NM from the US east coast. The US east coast has a very large region of 50-60 m depths within 60 to 90 NM of the coast from Delaware to Massachusetts. There is roughly about 50,000 square NM of area from south of Nantucket to east of Cape May that lie between 50 and 60 m depths. Assuming that two wind towers are spaced in every square NM, this area could potentially support 100,000 wind turbines. There are also large areas of 60-60 m depths in the Gulf of Mexico. The Delaware to Florida region has 100 m depths about 30 NM offshore but in a narrow band. Shallow depths are available in the area around the Channel Islands and from San Francisco north, but are otherwise very limited. There is a ribbon around the entire US with 100 m depths, providing more than enough storage for US demand. 100,000 5 mw wind turbines placed offshore would provide for about 45% of the US electrical consumption.

The bottom composition in most of these areas is a sedimentary mud, or ooze. Under 100 m is generally considered the Continental Shelf, with a 1° angle. Beyond this depth is the Continental Slope, with typically a 3° angle.

### SUMMARY OF THE INVENTION

The potential of wind power is limited without storage options. Even Denmark, which uses wind for about 19% of the country's energy, is only at this level because it uses the hydro reserves of Norway and Sweden for buffering. Furthermore, the ability to sell energy primarily at times of peak demand improves the economics considerably. This invention provides a way to store several days of offshore wind and/or wave energy production, allowing each wind turbine to be a reliable source of high value, peak demand energy, at a cost less than for battery storage.

The system has air storage tanks located close to or on the sea floor. Wind, wave or possibly tidal/current energy drive a modified Archimedes type screw, or bubble pump. The helix may be tapered so that the internal volume matches the volume of the air as it is compressed. The compressed air is transported to the submerged storage tanks.

Besides compressed air, almost half the storage is stored in the form of heat. The bubble pump has an outer insulating shell or jacket which surrounds the helix screw, and allows the fluid that flows through the screw to recirculate in a closed loop. When in compression mode, the fluid inside the screw will exit the bottom and return up inside the jacket. This fluid will preferably be fresh water with anti-corrosive additives (i.e. antifreeze) to allow the density to match seawater. In this manner, the heat produced in compression can be stored and extracted when the screw is operated in decompression mode. The fluid (heat storage) volume will preferably be matched to the tank volume.

Stored air can be supplied to the bottom of the screw when energy is needed. The air will be warmed by the fluid, which expands the bubble size and increases the force each bubble exerts on the screw mechanism.

A wind turbine includes a power transfer means, typically a bevel gear with a “switch”, so that low value energy can be delivered down to sea level where it drives the screw. At peak times, the wind and/or the screw drive the generator. This has the potential to store 24 hours of 5 mw per 150-200 m3 of 150 psi (95 m depth) air storage. For comparison, storing (1100 GJ) in batteries (assuming 15 Whr/$, or $67/kWhr) would cost about $22M. The efficiency of battery storage would be about 85% but with a life span of 6-10 years, as opposed to 30-40 years for pumped air storage. Alternatively, with two pumps, one pump will be dedicated to compression/power storage, and another to decompression/power generation.

If the area has significant wave resources, the tower of the wind turbine can be a base for typically four 10-14 m diameter spar type buoys, which could produce up to about 400 kw each from the waves.

Electricity generation accounts for about 2.4 MMT of carbon dioxide production out of a total of 6 MMT produced by the USA. Of the 2.4 MMT produced, about 2 million is produced by coal-fired plants, which accounts for 44% of US electricity. If wind is to take over a big chunk of the coal-fired electrical production, it will need to be a reliable, on demand source.

Air compression is achieved using an Archimedes style air or bubble pump, using an enclosed spiral or helix screw. Such a pump essentially is a series of incline planes which trap and transport a pocket or bubble of air up or down as it is rotated. The bubbles will exert a constant force, based on bubble size, which in turn is dependent on the depth/pressure and temperature. The volume of air will decrease by about 50% every 33.9 ft or 10.3 m of depth. Offsetting this, the temperature of the air will increase significantly as it is compressed. 100 m depth would result in 300° C. temperature, assuming no heat transfer.

Large heat storage capacity in the bubble pump is desirable, as about half the energy available from the compression of air is stored in the form of heat. The heat storage fluid volume must match the energy storage requirements for a specified increase in fluid temperature and total energy storage required. This fluid and the heat contained therein are retained via the use of the outer insulating jacket that allows the fluid to be continuously circulated and retained. Small holes may be drilled in the section of the inner screw walls directly above the spiral (i.e. where only fluid, and not air, is located) to increase heat transfer to the fluid in the outer jacket.

To pump a significant quantity of air, the volume of the spiral cylinder will be larger at the top by 3-4 times the diameter at the bottom. Once the air is above 90% compression, pressure goes up but little additional reduction in volume will occur. The screw will run down at about a 45° angle, so the length of the screw will be depth×about 1.35.

These are massive but relatively simple objects, whose cost is less than the multi-stage compressors, intercoolers or heat exchangers and heat storage tanks used in conventional CAES plants to compress the air, together with heat recuperators and turbines used in decompression. No fossil fuels are needed. The speed of the bubble pump closely matches the speed of the wind turbine, minimizing the need of gearing.

The amount of air scooped up in each rotation during the compression phase can be adjusted (to account for varying amounts of power available) by adjusting the height of fluid in the tube. As the fluid level is raised, less air will be captured by the screw, and thus less power will be needed to transport the smaller bubble down. Likewise, in decompression mode, the amount of air introduced into the bottom of the pump can be regulated to produce the needed force to spin the generator at the desired speed.

Although a single bubble pump per wind turbine is less expensive, there are many advantages to a double pump configuration, i.e. two separate pumps in one insulating jacket. The upper pump would handle decompression, the lower pump would be compression only. The primary advantage is that the wind turbine can run for maximum power output, with no need to adjust for varying wind speeds, by feeding all the power to the lower pump. The upper pump will run only the generator, and the speed of the bubble pump can be constant. The generator can also reverse the upper pump, to store energy at off peak times if needed.

The stored air will be close to the temperature of the surrounding water, which on the continental shelf off the Atlantic Bight will range from 5-10 c (average 7.5 c) in the late winter/spring to 12-16 c (average 13.8 c) temperature in the late summer/fall. Thus, in the winter, the water will likely add to efficiency, whereas in the summer, efficiency will be depressed by air that is cooler than the water. In any case, the air bubble will quickly be warmed by the fluid (provided the end of the compression phase was fairly recent), increasing the size and force exerted by the bubble.

Other objects and advantages of the present invention will become apparent from the following description of the preferred embodiments taken in conjunction with the accompanying drawings, wherein like parts in each of the several figures are identified by the same reference characters.

### BRIEF DESCRIPTION OF THE DRAWINGS

FIG. 1 is a broken perspective view of a pump according to the present invention.

FIG. 2 is a perspective view of a wind turbine for harnessing wave power in accordance with the present invention.

FIGS. 3 and 4 are broken views of an energy storage tank in accordance with the present invention.

FIG. 5 is a perspective view of a wind turbine coupled with a storage tank via a pump according to the present invention.

FIGS. 6 and 7 are perspective views from different angles of a wind turbine on the sea subsurface in accordance with the present invention.

FIGS. 8, 9, 10 and 11 are perspective views of a wind turbine/wave action motive means coupled with a pump in accordance with the present invention.

### DETAILED DESCRIPTION OF THE INVENTION

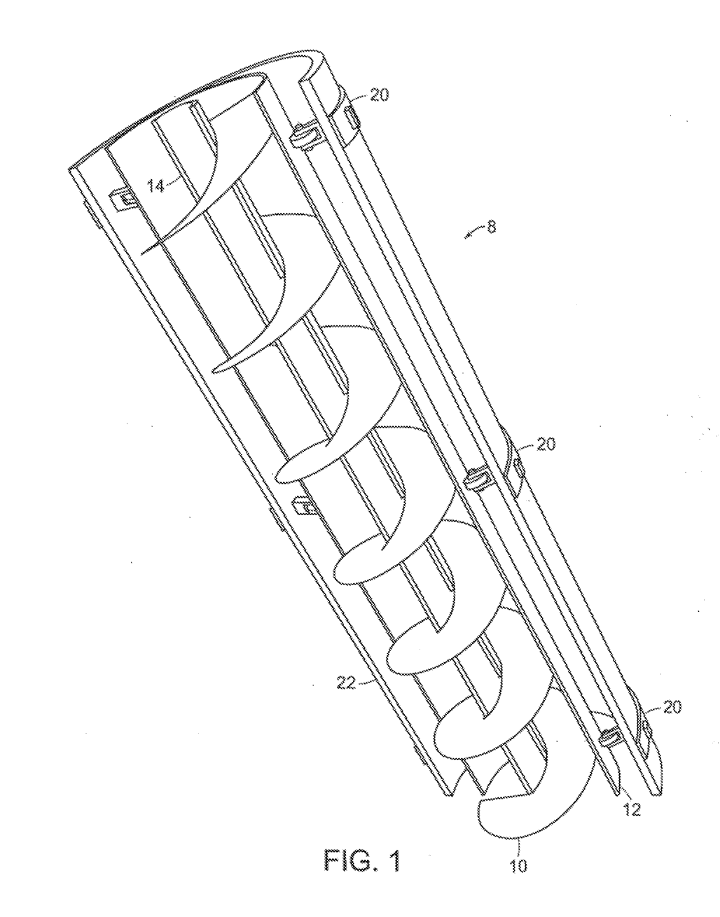

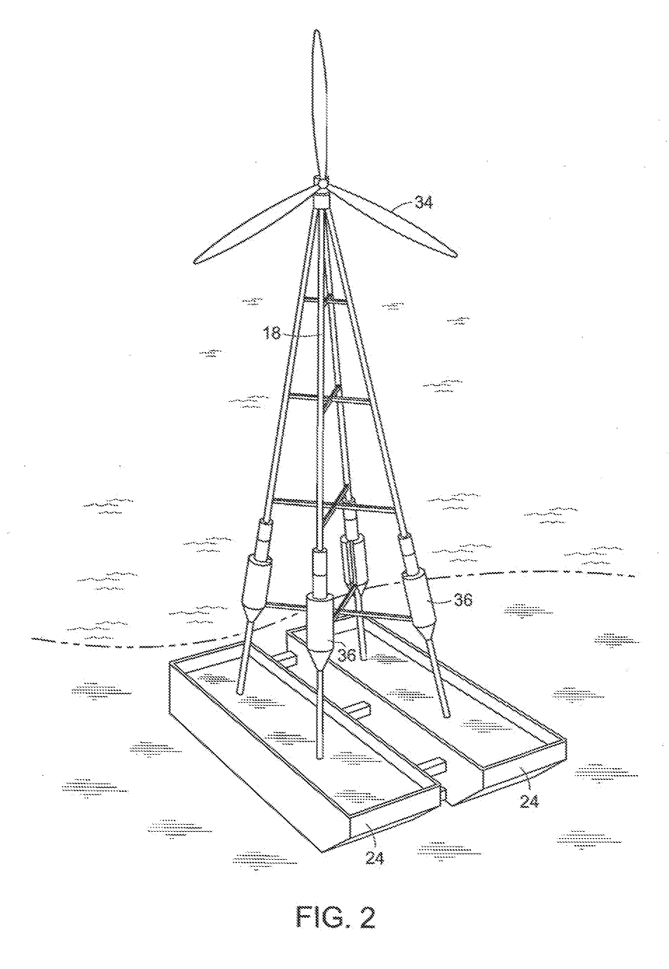

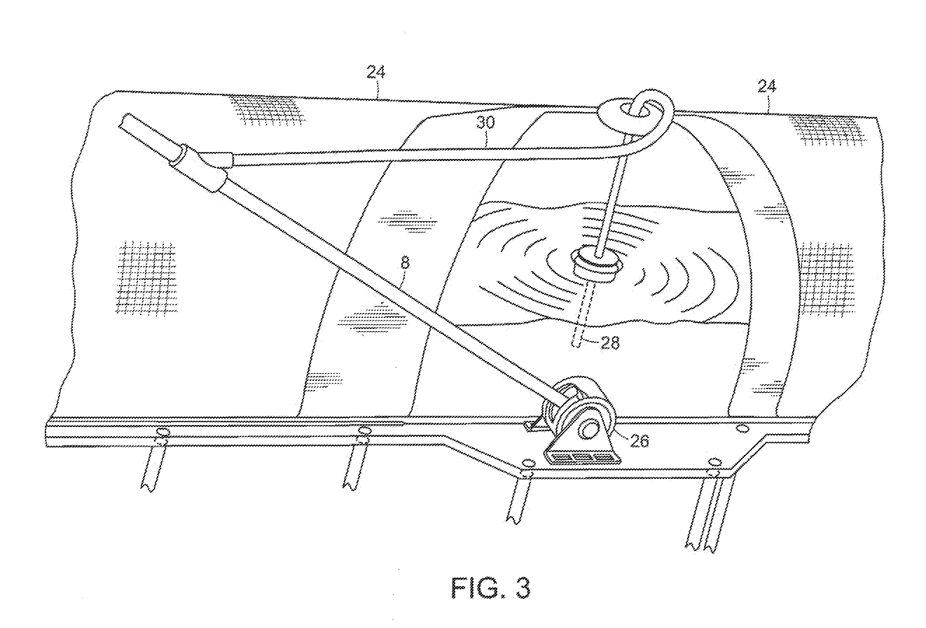

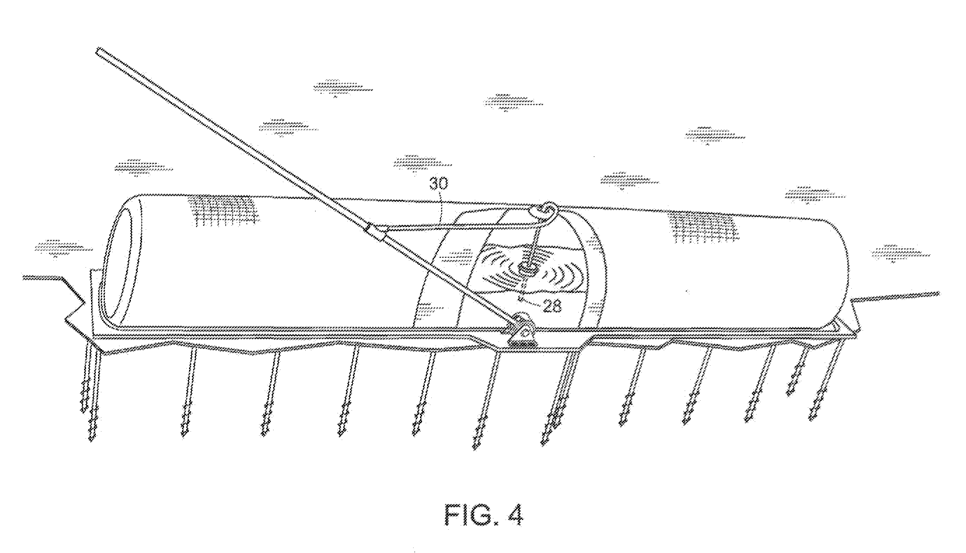

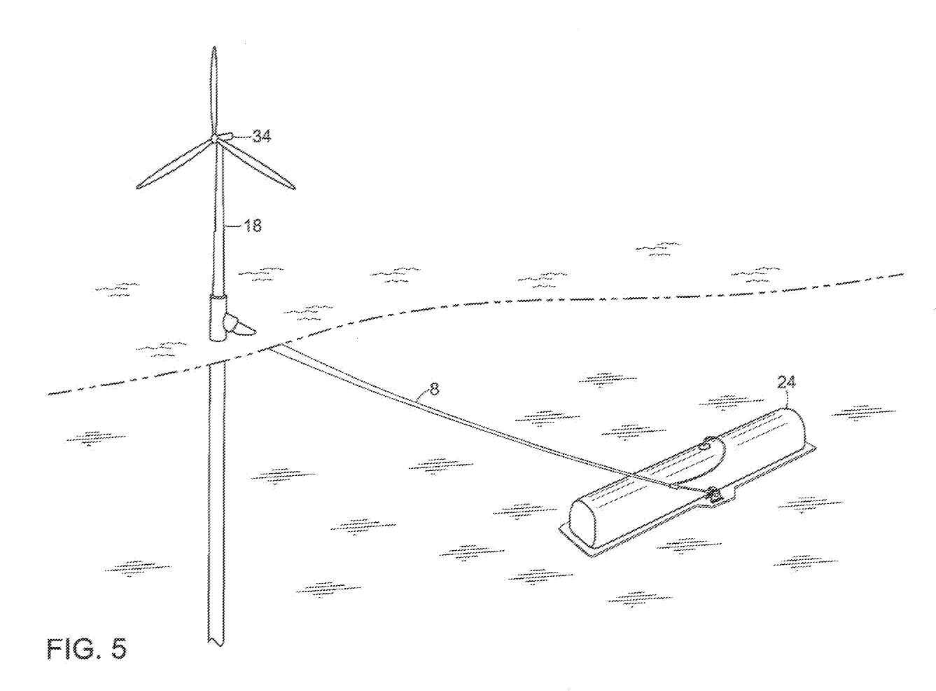

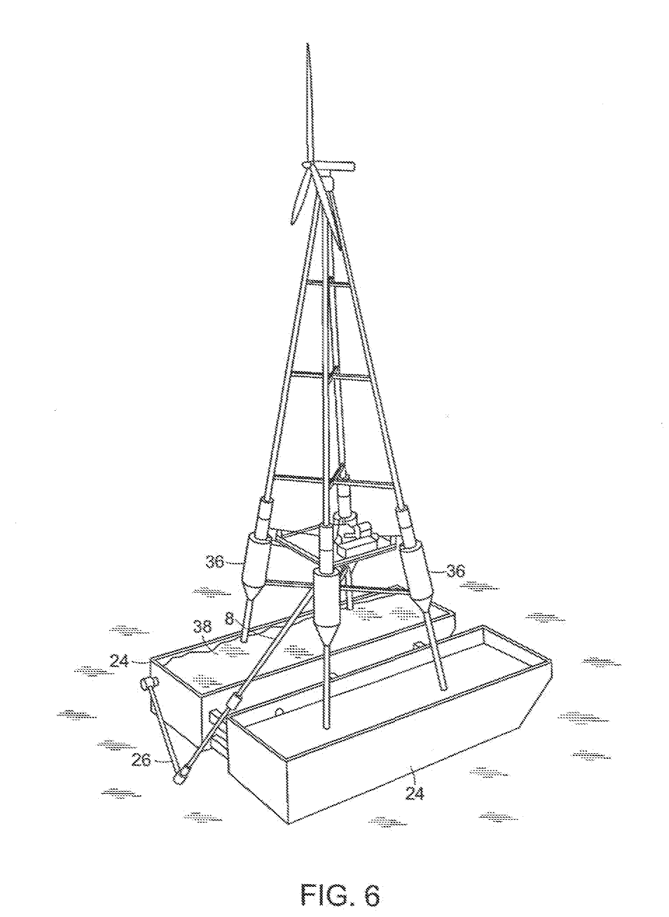

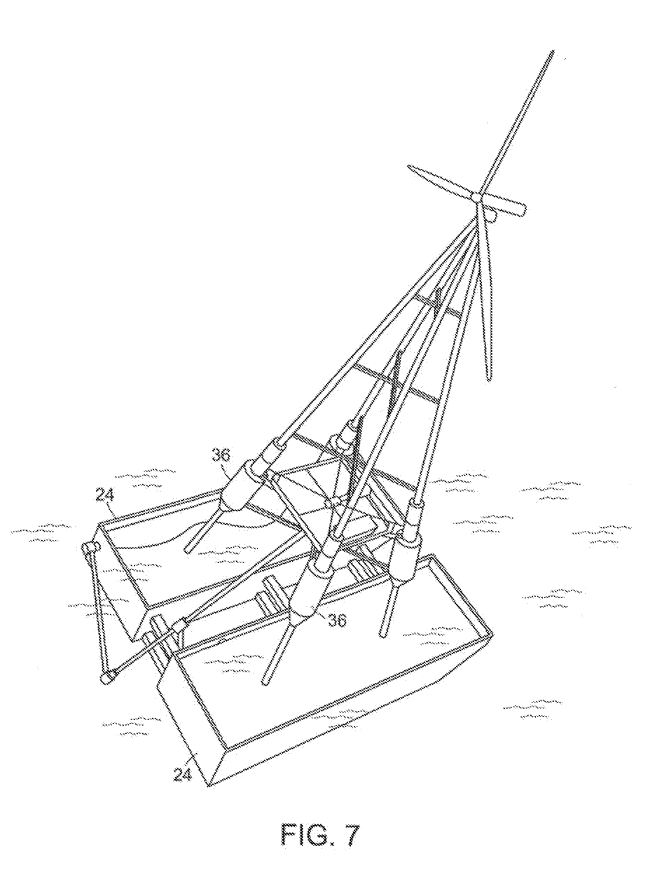

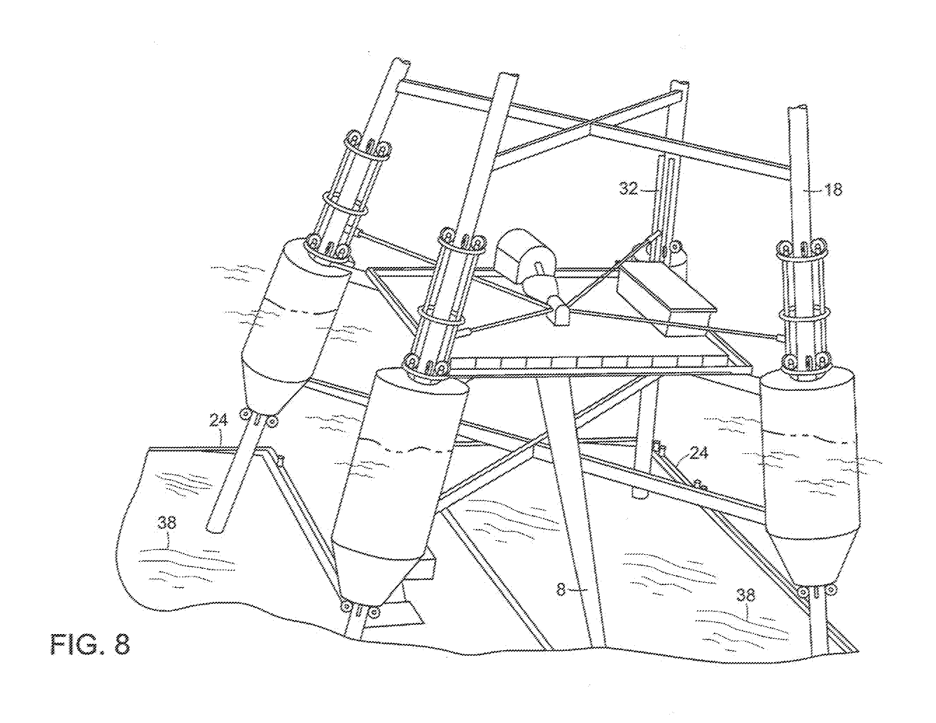

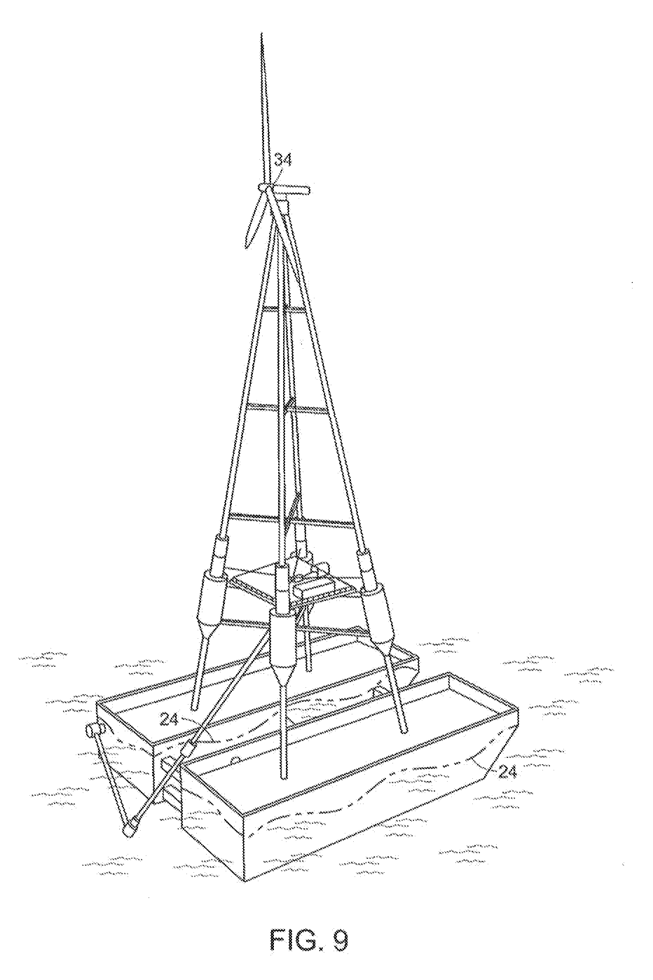

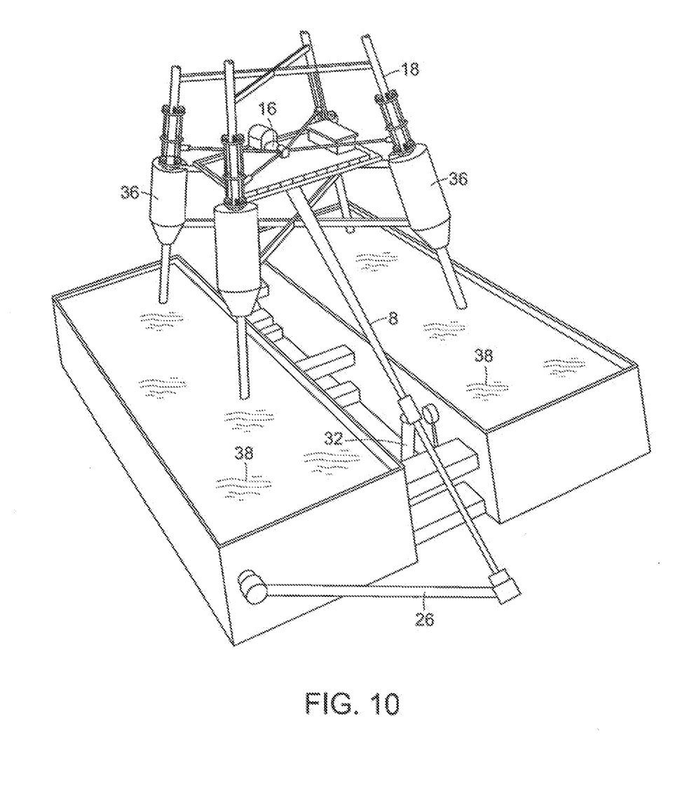

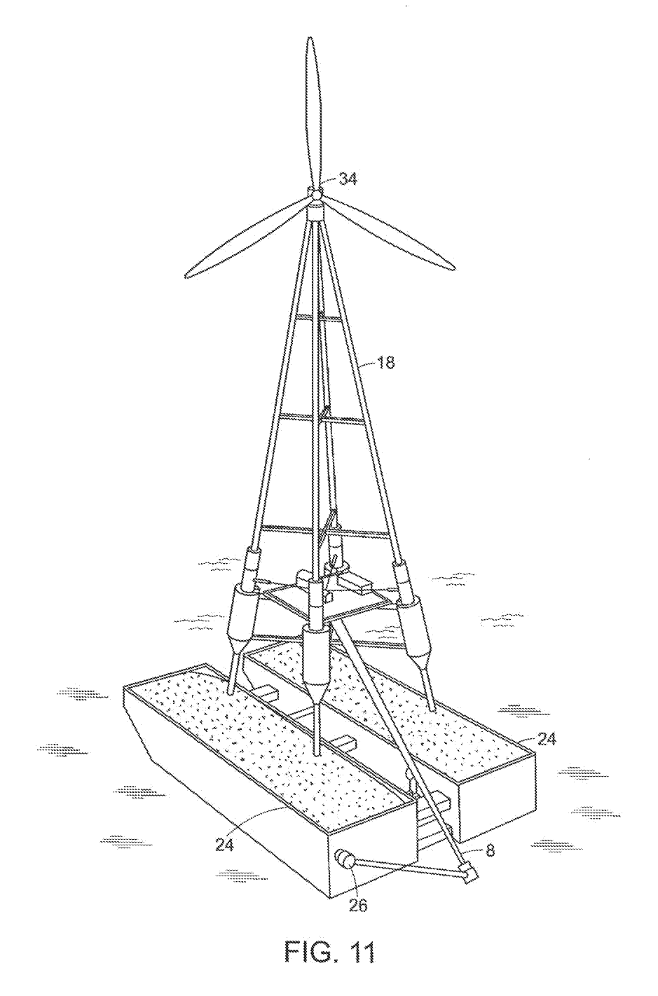

A pump according to the present invention, as shown in FIG. 1, can be formed of welded steel plate. The pitch and number of blades is dependent on heat transfer rates, but likely there will be between 1-3 blades. Unlike a conventional Archimedes screw, the blades will be welded to the pump shell, so there will be no “leakage”.

One method to manufacture the pump is to use slotted “washers”, whose ID is about 30-50% of the OD. The washers will have one cut or slit from the ID to the OD. The washers will typically be slid over an aligning pipe, then one edge from one washer will be welded to the edge of the adjoining washer. This process is repeated until the stack is high enough to create a workable length, e.g. 10 m long when pulled apart. The adjoining washers can gradually increase in OD to provide the needed taper for the upper section, although the ID should stay constant for each length.

When a workable length (for production purposes) of washers has been welded together, the washers will be pulled apart to create the needed spiral spacing. The outer surface of the pump will then be welded on, using a roll stock steel that will be unrolled and welded to the edges of the pulled apart washers. For example, a 4 m OD washer with a 1 m ID might use 1.5 m wide roll stock to be edge welded. These lengths will then be stockpiled to be joined with others when needed. The ID of adjoining lengths can vary, of course. The lengths will then be welded together via access plates, which will then be closed off.

At the top end, a shaft may be welded in, to transfer the torque to the turbine tower. The shaft has a machined outer surface to allow bearings and water seals to be slid over. Machined collars will also be fitted over the pump at spaced intervals, particularly at the joints to help reinforce them and provide a smooth surface for rollers to roll against. A section near the bottom may also be fitted with a machined collar, which allows a smooth surface for an air inlet valve to bear against.

The steel pump will need added weight so as to be neutrally buoyant when in operating mode with bubbles trapped in each pocket. One means of adding weight/ballast is to use a central pipe, which may also be used to align the plates, as a reservoir to be filled with concrete. In this case, the aligning pipe used in production may also be the reservoir for concrete or some other weight. Concrete rings can be cast over the pipe, or a double wall steel pipe can be added and weight poured into the space between the inner and outer wall.

The outer jacket has an ID significantly larger than the OD of the adjacent bubble pump shell dependent on how much heat storage is needed. The outer jacket can be steel or molded fiberglass wrapped with foam and over-coated with a noncorrosive material such as fiberglass, in the upper, tapered section. Additional ballast will be used to keep the jacket neutrally buoyant. Corrugated plastic pipe can also be used. The jacket will retain the heat in the fluid and allow it to run in a closed loop. When the pump is in compression mode, the jacket will allow the fluid, which will be pumped down with air, to return back to the surface. In decompression mode, the fluid direction in the jacket will be reversed. The fluid will warm the bubbles, expanding their size. Larger bubbles provide more force.

If a double pump arrangement is used, the insulating jacket can have an oval cross section to accommodate the two separate bubble pumps and can be molded fiberglass (if gradually tapered) or steel with a foam overlay.

At mid to lower depths, the outer jacket may no longer be tapered. Untapered round sections can be formed of, for example, corrugated plastic sewer pipe, which is available in sizes up to 1.5 m/60″ diameter. The corrugated construction of these pipes provides a 6 cm/2.5″ air gap between the inner and outer walls, providing needed insulation. Extra insulation and ballast can be glassed on if needed. By wrapping the outer surface with an external fiber “blanket” to hold warm water close to the pipe, much as marine mammals use thick fur to trap warm water, the heat storage properties can be further improved. Marine growth will also serve the same purpose.

To keep the pump centered in the jacket, urethane or some other composite rollers will be fitted at spaced intervals for each pump. If installed from the outside, they can be removed for servicing. The inner bubble pump, which must carry significant torque loads, will be the primary structural member. The outer shell principally retains the noncorrosive heat storage fluid.

The pump will be reversed by allowing a measured amount of air into the screw from the storage tank and capturing the energy with the generator. In order to allow the air bubbles transported down to the tank to bubble out, without losing the heat retaining fluid, the bottom end of the bubble pump connects to a tube which in turn connects to the top of the storage tank and is above the surrounding sea level. In this manner, the heat retaining fluid will not flow out with the bubbles. The exit of the bubble pump must be below the air level in the tank.

As long as the top of the connection tube is in a pocket of air and above the surrounding sea level in the tank, the heat retaining fluid will not overflow the snorkel. The height of the snorkel allows for slight adjustments in the fluid level, which may be used to adjust the amount of air captured by the screw, and thus how much energy it can store. The speed of the screw is another means of adjusting energy storage, but the screw should operate at high speeds.

The pressure of the heat retaining fluid must match the pressure of the seawater at the level of the tank. The density of the working fluid should be roughly equal to the density of seawater. If the density is slightly less, the level of the fluid will need to be somewhat higher than the surface level of seawater to compensate.

There are several means of allowing air back into the screw. One option is a supply tube from the top of the tank to the bottom of the pump. Another option is a tilting tube.

The tilting connection tube or pivot tube uses a short length of roughly horizontal tube to connect the bottom of the bubble pump to the top of the tank. The tilt tube must be hinged or use a flexible connection at both ends to allow some movement. The tube will be tilted so as to allow bubbles to flow into or out of the tank. When in compression/storage mode, the pivot tube will be angled so the exit point of the screw pump is slightly below the air level in the tank. When in decompression mode, the lower end of the pump will be raised slightly, allowing air to flow back into the pump.

The mechanism to raise and lower the screw can be a separate strut or series of struts tied to a float inside the tank, such that the lower end of the pump is normally slightly below the air level in the tank. A hydraulic piston can raise the screw slightly to switch to decompression mode. The strut length(s) would be such that some air will always be left in the tank.

The present invention has the advantage that the pump level matches the level of the air in the tank, minimizing inefficiency. Air is not pumped to the bottom level of the tank and allowed to bubble up a significant distance (if the tank is close to empty), which represents lost energy, but instead is pumped to just below the current air level of the tank.

With a double pump, two roughly parallel tubes will be fitted. The lower tube will collect the bubbles transported down and feed them to the tank. The upper tube will return the bubbles by using a valve to control the inflow. The upper tube can be set so it is just above the tank level, with the lower tube always just below tank level.

A supply tube system will use a separate pipe to supply air to the tank. The advantage of this method is that the screw pump will be stationary. The return/decompression tube will run from the top of the tank to the underside of the screw. A small hole will be cut into the shell of the pump at the level of the top of the tank, to allow air in. The bottom end of the pump will be fitted with a snorkel, which extends up to the top of the tank, where there is always a pocket of air, to allow air in.

A needle valve is orientated from the bottom up, and the upper surface of the needle valve is in tight contact with the machined surface adjacent the inlet hole. When the hole is lined up momentarily with the needle valve (and the remote controlled valve is open) air can be introduced into the pump from the tank in a controlled manner. As with the upper seal, the needle valve will use a tensioning system, such as via an extension spring, to maintain a constant force as the contact surface gradually wears away.

As the pump is launched, it will be filled with the working fluid. If the pump is integral with the tower and tank, then the entire unit will be lowered until the pump is parallel and just above the water surface. The pump will be filled with the noncorrosive heat storage fluid as the lowering process continues. This fluid will typically be fresh water with ethylene glycol to match the density of salt water.

For tidal or current powered applications, the pump can have an additional outer helix to capture the energy from the moving water where the current turns the pump directly. Compression only systems are used, and the pump becomes a one-way unit, because the moving water will be in contact with the pump. A separate decompression pump can connect from one or more tanks to the surface-deployed generator, or the air pressure can be run through pipelines ashore. If a turbine based CAES system is not suitable due to moisture in the air, especially if the unit operates in salt water, a modified version of a hydropower turbine may be more suitable. Water can be injected into the air stream to allow conventional hydropower turbines to be used.

If the heat is lost, efficiencies will fall to the 40% range. If the water exiting the bottom is captured, stored and used to warm up the air returning to the surface (i.e. the return pipe includes an outer jacket where the heated water is stored) efficiency can be improved.

Tidal or current applications can use a pump with a spiral nebula style (i.e. with curved arms) exterior similar to a vertical axis windmill. However, the efficiency is far less (probably in the 40% range) compared with the insulated closed loop system discussed above. Such applications may be able to start on or near land, and may in this case run directly to an electrical generator with no compression or storage.

Fouling can be an issue with such applications. If a brush arrangement is fitted so as to rise or submerge when rotated through the use of “wings”, fouling can be avoided. If the brush arrangement is buoyant, the brush arrangement will rise when the rotor stops rotating at slack tide. If mostly out of the water at such time, the fouling of the brush arrangement will also be limited.

The wind turbine can also directly drive the screw with no electrical generator. Decompression/energy extraction can occur shore side. This makes the wind generator much simpler and possibly better suited for deeper water installations. Again, if the heated water is stored in a shell surrounding the return air line that runs to the compressor, then efficiency can be better than 50%. However, it is likely to be more cost effective and efficient to collect electricity from numerous offshore installations rather than collecting air, as the cost of air lines is more than the cost of electric lines.

Two separate bubble pumps can be used for each turbine, a compression only pump and decompression only pump. In this case, all the power inputs from the wind turbine or wave power are fed to the compression turbine all the time, which preferably is located below the expansion bubble pump and in the same insulating shell sharing the same fluid. The advantage is that the gearing and transfer mechanisms are much simpler. Even more important is that the force fed to the generator can be constant such that wind gusts are not an issue.

A standard turbine tower can be somewhat altered for use with the present invention. The blades of the turbine itself can be somewhat smaller than would be otherwise, since power can always be added from the pump to spin the generator at the rated speed. This will be especially true where wave energy is another power input. The turbine blades, shaft and bearings can be sized for roughly a 3-4 mw turbine if a 5 mw generator is fitted. If desired, the wind turbine can drive the generator directly.

After the turbine and main bearing, the 90 degree power take off is fitted in the center of the horizontal upper housing bearing to send down to or return power up from the pump, in combination with the gearbox. The shaft will rotate in different directions depending on whether power is being sent to or received from the bubble pump. The vertical shaft will typically have three positions.

The following analysis assumes one is looking back from forward of the wind turbine rotors for horizontal shafts, or looking down from above the wind turbine for vertical shafts, and that the wind turbine/generator rotates clockwise.
1. Swung forward (for example) to engage the forward edge of the bevel gear, and the vertical shaft is driven clockwise to pump air down.
2. When the power is needed from the bubble pump, the shaft will be swung aft, and the now reversed shaft runs counterclockwise to drive the generator clockwise.
3. When the wind power matches the energy required, the bevel gear will take a middle position, and no energy is transferred to or from the pump.

If wave inputs are added, the wave power shaft will only rotate in one direction, so the wave shaft will typically be external to the main shaft, and not directly connected. A clutch/transmission will allow wave power to either rotate the generator directly, or rotate the bubble pump. The present invention allows several options detailed below:
A. Electrical power needed, wind energy is enough, no wave energy—Rotor directly connected to generator, via a clutch between the wind turbine and the generator, the bubble pump is locked;
B. Electrical power needed, wind energy is enough, some wave energy—Rotor directly connected to generator, wave power is diverted to pump air down to submerged storage tanks;
C. Electrical power needed, some wind power, some wave power needed—The clutch between the rotor and the generator is engaged, the shaft from the wave generator transfers additional power up to the generator using the main shaft. The bubble pump is locked, with a clutch open to disengage it from the main shaft;
D. Electrical power needed, no wind energy, wave energy enough—The clutch between the wind turbine and the generator will be disconnected, the main vertical drive shaft, rotating counterclockwise, will run power up to the generator. The bubble pump is locked and disconnected;
E. Electrical power needed, no wind energy, wave energy and stored energy needed—The clutch between the wind turbine and the generator will be disconnected, the main vertical drive shaft, rotating counterclockwise, will run power up to the generator. The bubble pump is unlocked and connected, with enough air fed in to allow sufficient power;
F. Electrical power needed, no wind energy, no wave energy—The cutch between the wind turbine and the generator will be disconnected. The tank valve will be adjusted to provide the needed airflow;
G. Electrical power not needed, wind energy is present—The wind energy is directed down to the bubble pump; and
H. Electrical power not needed, some wind power, some wave power—Both power inputs are fed to the bubble pump. fluid level and/or speed can be adjusted to maximize stored power;

The double pump arrangement simplifies many aspects of the present invention. All energy inputs directly spin the typically lower compression-only bubble pump. The effect of wind gusts or lower wind speeds become far less important, as the speed of the compression pump is not important. If wave energy is added, both devices will be able to feed as much power as possible to the compression pump, by including ratchet connections to allow one power source to spin the bubble pump while the other power source is stationary or spinning below a significant speed. The decompression pump will be connected directly to the generator, allowing a precisely controlled amount of power to be applied to the generator, thus minimizing inefficiency. If needed, the generator may be able to reverse the compression pump to store excess energy in off peak times.

If located in a suitable location (i.e. 40-60 miles off the northeast coast or much of the west coast), the wind tower provides a useful base for adding wave power inputs for little extra money. Wave energy is often present (due to the ability of waves to travel far from the storm that produced them). Therefore, significant wave energy is often present even during windless days, especially in the fall, winter and spring months from north Atlantic storm activity often over 500 nautical miles away.

Although several configurations are possible, one preferred embodiment uses spar type buoys arrayed around each leg of a 3-4 leg tower. The buoys will be about 10-15 m in diameter at the water's surface, with a length above the water equal to the maximum wave height. These buoys slide up and down the 3-4 vertical tower supports. The buoys can be slotted top to bottom, to allow the buoys to be removed from the tower support. The buoys are normally retained by upper and lower sets of rollers fitted to the buoys to roll against the tower support.

Inside the slot, the buoys can have a vertical rack with opposing angled gears. A cog wheel slides over and engages one side on the up stroke, and the other side on the down stroke. The cog wheel has a slotted bearing support, allowing the cog wheel enough movement to slide side to side and engage either rack. This cog arrangement is located as part of a platform that should be above 95% of the highest waves, or about 5-10 m above sea level. This platform will be supported by the legs, with the support structure passing through the buoy slot to the legs. The distance between legs will be about 50 m at this point.

Power from the vertical drive shaft may run through additional gearing to optimize the speed. Power can either be sent up to the generator or down to the bubble pump. If a double pump, all the power will run to the compression pump.

The buoys are preferably transported to the installation site attached to the tower but empty of the needed ballast. They can be used to control the heel of the structure to some degree as it is lowered. After the structure has been sited, the buoys can be filled with ballast material to achieve the needed weight. Additional tuning by adding or removing weight is desirable, typically by filling separate internal tanks with seawater. If the tower is not incorporated into a barge, the buoys themselves can provide the buoyancy needed to transport the wind/wave tower to the site, after which the tower can be lowered using the buoys as a floating platform. This would allow the towers without the storage capabilities to be sited more easily, but is more risky than the barge method.

The tanks can be incorporated into the tower base. For shelf water depths (about 40-100 m), the tanks can be a welded tank located at the bottom of the tower base. The tower will use roughly 10 degree angle legs (3 or 4) running from the wind turbine down. The legs can serve as the support/guide for the wave energy buoy. The slotted nature of the buoys allows the legs to be tied to each other as needed and also allows the shaft running from the tower to the bubble pump to pass clear of the wave buoys. Sand or other ballast material is placed over the tank to counteract the buoyancy and anchor the tower. Although the bottom angle should be considered in the manufacture of the unit (e.g. if intended for a bottom with a one degree slope, the tower should have a one degree angle relative to the base), some leveling can be obtained by the placement of the ballast.

Such an arrangement allows the complete system to be deployed at one time. The weight of the tower helps weigh down the tank. The ballast dumped on top of the tank is removable by normal suction type dredges, allowing the entire tower to be removed if desired. Air can be pumped in when the ballast is removed to help extricate the tank from the bottom. If a hurricane is approaching, the air in the tank should be removed, allowing the ballast to help provide additional stability. The tank(s) will develop considerable hydraulic suction attachment if the bottom is of a soft nature, as is normally the case. This may allow less ballast to be used than would otherwise be needed. Even if the air storage tanks are full of air, and there is no ballast, the suction formed with a soft bottom can hold the tanks in place. A lip around the bottom of the tank can further enhance the suction effect, but would require air to be injected to break the suction and remove the tank.

The tanks may be formed by connecting two or more modified aggregate type barges, which are designed for gravel, sand, etc. to be loaded on the flat top deck. The barges will be higher for more internal volume than normal. Three barges 100′ wide×400′ long×50′ high will give a volume of 6,000,000 cubic feet or 170,000 m3; enough for 24 hours of storage. These interconnected barges will provide the base for the wind tower, and allow it to be towed out to sea. By closing the air transfer connection between the barges, sinking one barge and allowing the tower to heel over till the submerged barge touches the bottom on the outside lower edge, then sinking the additional barge(s), the units can be quickly towed out and deployed without additional equipment. As the first barge sinks, the remaining barges, which should be dry inside, will keep the sinking barge level. Once the submerged barge is on the bottom, it will keep the remaining barges level as they are sunk. If needed, the tugs can attach a long cable (greater than the depth of the water) to the barge being sunk, and another tug would attach a cable to the tower in an opposing direction. The tugs can then be able to control the rate of descent of the barge, so as to provide a soft landing. Air bags or the wave floats can also serve this purpose.

Typically, the combined beam of the barges should be about 50% greater than the water depth, to limit the maximum heel of the tower as one barge is sunk to the bottom. The barges have a normal steel bottom to maintain stability, and also include vertical supports to transfer load from the ballast gravel to the sea floor. The ease of installation and retrieval and the manufacture of the barges at a low cost shipyard and towing a string of them unassembled to an assembly point close to the installation location is extremely advantageous and cost effective. Once the barges are sunk, interconnecting valves can be opened to allow air to transfer between the barges.

A SES (submerged energy storage) system can also use a tethered tank with a coated fabric structure for more capacity. The structure will be anchored by a series of pipes connected to the sides, forming the fabric into a domed structure. These pipes would be driven into the sediment that exists along the shelf or slope area, which is over 300 m deep off the east coast of the US. Sediment depths of the Continental Shelf are much less off the US west coast, but generally deep enough to anchor the structure. The pipes cannot be removed, due to hinged sections which flip down to horizontal when pulled up. Materials such as hypalon, polyurethanes, and several thermoset resin coatings over, for example, polyester should have a lifespan of over 50 years. The fabric rolls will be jointed so seams are not loaded (i.e. the seams run over the top). This tank could also be made in long segments that are interconnected, allowing a means of sharing energy between various regions. The tank could follow the 100 m contour to stretch from Maine to Florida. The interconnected segments can use fiberglass end plates that are bolted together, with means to close off the airflow.

Ballasted concrete tanks are another option but are more expensive. A submerged energy storage system will require almost one cubic foot of concrete and/or ballast for each cubic foot of air stored. Assuming a capacity of approximately two million cubic feet or 58,000 m³ of gas at one atmosphere (sea level), an unballasted tank will require about 70,000 cubic yards of concrete and 4,000 tons of steel, at a high cost per tank. A ballasted approach allows a lighter, less expensive (and potentially larger) tank. The ballasted tank would require about 20,000 yards of concrete and 900 tons of steel with about a 50′ layer of ballast rock laid on top, at a substantially lower cost per tank. Such tanks would require a large support area or footing to avoid sinking into the bottom silt. This footing would also likely provide a lip to collect as much of the ballast rock as possible.

Inasmuch as the present invention is subject to many variations, modifications and changes in detail, it is intended that all subject matter discussed above or shown in the accompanying drawings be interpreted as illustrative only and not be taken in a limiting sense.

What is claimed is:

1. A submerged energy storage system comprising a storage tank resting on a sea floor, a motive means operated by wind or wave action, a pump operated by said motive means including an enclosed rotatable helix screw operating in a liquid, means for allowing a gas to become trapped in the helix as it rotates, such that said gas is compressed by rotating said screw, and means transporting the compressed gas from an upper low pressure level to a lower high pressure level to be supplied to said storage tank.

2. The submerged energy storage system recited in claim 1 wherein said screw is rotatable in a first direction to compress said gas for storage and in a second opposite direction to obtain useful work from the stored compressed gas.

3. The submerged energy storage system recited in claim 2 wherein said liquid is heated by compression and retained and/or recirculated.

4. The submerged energy storage system recited in claim 3 wherein air volume is controlled by adjusting the position or height of the lower end of the screw.

5. The submerged energy storage system recited in claim 1 and further comprising an enclosure containing a first helix screw primarily used for compression/power and storage and a second helix screw primarily used for expansion/power delivery, said enclosure retaining the fluid produced by compressing the gas.

6. A wind turbine having support legs and buoys connected to said wind turbine towers support legs, said buoys driving the generator of said wind turbine.

7. The wind turbine recited in claim 6 wherein said buoys rotate a helix screw to pump energy to a submerged storage tank.

8. The wind turbine recited in claim 7 wherein said buoys are mounted coaxially to the tower support legs, with guide members or rollers to engage said tower support legs.

9. The wind turbine recited in claim 8 wherein said buoys are fitted with one or more racks, with a mating gear fitted to engage said rack and transfer rotational force to the generator and/or compression helix screw.

10. The wind turbine recited in claim 7 wherein said storage tank is attached to the bottom of said tower and ballast sand, gravel or other dense material is placed on top of the tank to hold it in place.

11. The wind turbine recited in claim 2 wherein said storage tank is flexible and connected to the lower end of the helix screw, said tank secured to the sea floor via tension members.

12. A method of deploying a tower secured to two or more connected barges, comprising the steps of
towing said connected barges together to a siting area;
sinking one barge in a controlled fashion until the outside edge of said barge is in contact with the bottom; and
sinking the other barge in a controlled fashion.

13. The method of deploying a tower as recited in claim 12 and further comprising using buoys attached to the tower to control the rate of sinking.
